(19) United States
(12) Patent Application Publication
(10) Pub. No.: US 2005/0177456 A1
(43) Pub. Date: Aug. 11, 2005

(54) Method for communicating with buyers who chose a competitor

(76) Inventor: Michael T. Rossides, Scottsdale, AZ (US)

Correspondence Address: MICHAEL T. ROSSIDES, 11167 E. MIRASOL CIRCLE, SCOTTSDALE, AZ, 85255, US

(21) Appl. No.: 11/053,728

(22) Filed: Feb. 7, 2005

Related U.S. Application Data
(60) Provisional application No. 60/542,887, filed on Feb. 6, 2004.

(51) Int. Cl. G06F 17/60

(52) U.S. Cl. 705/26

(57) ABSTRACT

An expected value system for paying and qualifying realbuyers (EVSPQ-RB) is an online database system that enables a seller to pay conditional, expected value payments to realbuyer prospects for their attention to a message. In an EVSPQ-RB, users are eligible to win payoffs if they match the realbuyer conditions set forth by a paying seller. A user who has conditionally won a payoff can then claim the payoff. An EVSPQ-RB tracks the users who have accepted a seller's payment offer and who have claimed a corresponding payoff. The invention is a method for improving an EVSPQ-RB comprised of the following steps: a. upon a seller's request, presenting the seller a list of users who have claimed a payoff from an offer made by the seller via the EVSPQ-RB, b. enabling a seller to specify and view a list of claimants by the product or service bought, or by who the seller bought from, c. enabling the seller to select any of the claimants in the list to be queried, d. enabling the seller to query the selected claimant(s) via email, web form, interactive voice response, and/or phone conversation, e. enabling a seller ask payoff claimants a market research question, f. enabling the seller to receive answers back from the claimants.

### CROSS-REFERENCES TO RELATED APPLICATIONS

This application was preceded by, and claims priority of, U.S. utility application 10/700,836, filed on Nov. 3, 2003 and U.S. provisional application 60/542,887, filed on Feb. 6, 2004 and PCT application US2004/036857, filed on Nov. 3, 2004.

### STATEMENT REGARDING FEDERALLY FUNDED RESEARCH

Not applicable.

### BACKGROUND—FIELD OF THE INVENTION

The invention relates to communicating with buyers who chose a competitor.

### BACKGROUND—DESCRIPTION OF RELATED ART

A large, if unseen, problem in the economy is that sellers usually do not know why prospects choose competitors' products (or services). A prospect might visit the Oakley Sunglasses website and then buy a pair of Ray Bans; a prospect may wander into Cafe Portobello but then eat at Zinc Bistro; a prospect might talk to a salesperson for Safety-Floor, Inc. but buy services from Clean-Floor, Inc. In these kinds of situations, a seller can rarely pose the question, “Why did you buy our competitor's product instead of our product?” to prospects who were exposed to the seller's product before buying a competitor's product.

That's because no efficient way has existed to find and communicate with these “got-away” buyers. That is, if a prospect is exposed to seller A's product, and if the prospect then chooses seller B's product instead, there is often no way for seller A to know about the sale and ask the prospect why she chose seller B's product.

U.S. patent application Ser. Nos. 09/536,727 and 10/042,975 describe a method and system that use the EVPM for paying qualified audiences for their attention to messages. application Ser. No. 10/042,975, in particular, elaborates on a method for identifying and paying for the attention of people who were going to buy a specified product or service.

The method disclosed in application builds upon the methods of application Ser. No. 10/042,975.

Applicant is unaware of any other method that is similar to the method described in this application. Existing methods mainly use mailing lists of competitors or use other profile data to try to reach people who have bought a competitor's product for the purpose of market research. The method disclosed here, thus, presents a novel approach.

### OBJECT OF THE INVENTION

The object of the invention is to provide a method for enabling a seller to communicate with people who were exposed to a seller's advertising and who then bought from one of the seller's competitors.

### BRIEF SUMMARY OF THE INVENTION

An expected value system for paying and qualifying realbuyers (EVSPQ-RB) is an online database system that enables a seller to pay conditional, expected value payments to realbuyer prospects for their attention to a message. In an EVSPQ-RB, users are eligible to win payoffs if they match the realbuyer conditions set forth by a paying seller. A user who has conditionally won a payoff can then claim the payoff. An EVSPQ-RB tracks the users who have accepted a seller's payment offer and who have claimed a corresponding payoff.

The invention is a method for improving an EVSPQ-RB comprised of the following steps:
a. upon a seller's request, presenting the seller a list of users who have claimed a payoff from an offer made by the seller via the EVSPQ-RB,
b. enabling a seller to specify and view a list of claimants by the product or service bought, or by who the seller bought from,
c. enabling the seller to select any of the claimants in the list to be queried,
d. enabling the seller to query the selected claimant(s) via email, web form, interactive voice response, and/or phone conversation,
e. enabling a seller ask payoff claimants a market research question,
f. enabling the seller to receive answers back from the claimants,
g. registering whether the seller has received an answer back, or whether a communication channel (such as a phone conversation) has been opened between seller and claimant.

### BRIEF DESCRIPTION OF THE DRAWINGS

There are no drawings.

### DETAILED DESCRIPTION OF THE INVENTION

Definitions

We use the term Method for Paying and Qualifying Realbuyers (MPQ-RB) to mean the method described in U.S. patent application Ser. No. 10/700,836, incorporated by reference. The definitions just below, except for that of got-away buyer, are taken from 10/700,836.

We use the term acceptance record to mean the record of the terms in effect when a user of the MPQ-RB accepted a pay-the-realbuyer offer, and identifying data about the user.

We use the term claimant to mean a user of the MPQ-RB who claims to be a realbuyer and who is owed a payoff if he/she is indeed a realbuyer.

We use the term verified realbuyer to mean a claimant (a user of the MPQ-RB who claims a payoff) who has been verified as a realbuyer under the terms of a “pay-the-realbuyer-for-attention offer.”

We use the term seller and advertiser interchangeably to refer to any businesses, profit or non-profit, or any person or entity that advertises a product or service.

We use the term product to refer to any product or service.

We use the term got-away buyer to refer to any person or company that was exposed to a seller's product and then purchased a competing product from (or leased a competing product from or borrowed a competing product from or donated an amount of money or other resource to) the seller's competitor.

Partial Solution: How to Locate “Got-Away” Buyers

The invention of U.S. application Ser. No. 10/042,975, the Expected Value Method for Paying and Qualifying Realbuyers (MPQ-RB), solves the problem of efficiently finding a sample of got-away buyers. To illustrate, let us assume that a fund seller, Janus, wants to know why investors chose a competitor, CGM, to manage their 401(k) plans. So:
1. Janus uses the MPQ-RB to pay prospects (realbuyers) for their attention, provided they invest with CGM within a specified period of time after being exposed to Janus's advertising message about Janus's funds.
2. Prospects who accept the offer are exposed an ad message (which can include a sales call or meeting) about Janus's funds.
3. A percentage of prospects who accept the offer will win the EV payment bets intrinsic to the MPQ-RB.
4. A percentage of those winners will be claimants of the EV bet payoffs.
5. Those claimants, the ones that say they invested with CGM, are the audience that Janus wants to reach—got-away buyers (also called realbuyers) who were exposed to Janus and yet invested with CGM.
6. As part of the MPQ-RB, those claimants will also have provided their ID and contact data so that they can be communicated with.

(Note: Depending on the implementation, a realbuyer may be eligible for payment if she bought from the seller that was paying for her attention. We will assume, for simplicity, that a realbuyer is someone who buys from a competitor and not from the seller that pays for her attention. So realbuyers, by this usage, are the same as got-away buyers.)

Locating a Larger Set of Got-Away Realbuyers

To locate a larger set of claimants, the MPQ-RB can include a two-stage EV payment bet process in which the probability of a recipient winning the first bet will be much higher than if a single payment bet is used.

The winners of this first bet will be asked, as part of the MPQ-RB, if they are realbuyers. Some percentage of these recipients will say, “yes,” and be first-stage claimants. These first-stage claimants make up a sample of got-away realbuyers that Janus wants to reach. The sample is larger than if a single bet, with a lower probability of winning, is used.

Note: If a two-stage EV payment bet process is used, the users who claim the payoff after the first-stage, that is the users who claim they are realbuyers after the first stage, will not all be actual, verified realbuyers. Verification takes place after a prospect has also won a second-stage bet. Thus, some percentage of first-stage claimants will not be eligible, on average. And thus, the set of first-stage claimants will be a set of highly probable realbuyers got-away buyers.

Rest of the Solution: Enabling Sellers to Communicate with Got-Away Buyers

The invention of this application is an improvement on the method of U.S. application Ser. No. 10/042,975—MPQ-RB, that is—an improvement designed to enable a seller to communicate with got-away buyers, and especially, to ask these got-ways buyers why they did not buy from the seller.

To fully achieve this object, the MPQ-RB requires additional steps for enabling a seller, who has provisionally paid a set of recipients for attention to a message, to separately ask winning realbuyers from this set why they did not buy from the seller and, instead, bought from the seller's competitor(s).

With additional steps, MPQ-RB can enable a seller to present this question to winning realbuyers using email, web form, interactive voice response, or a phone conversation. Accordingly, the MPQ-RB can include one or more of the following enhancement steps:
a. upon a seller's request, present the seller a list of users who have claimed a payoff from any RB offer made by the seller (this step was in application Ser. No. 10/042,975),
b. enable a seller to specify and view a list of claimants by the product or service bought, or by who the seller bought from,
c. enable the seller to select any of the claimants in the list to be queried,
d. enable the seller to query the selected claimant(s) via email, web form, interactive voice response, and/or phone conversation,
e. enable a seller ask payoff claimants a market research question such as, Why did you buy the product/service you bought rather than our product/service? and/or Why did you buy from our (named) competitor rather than from our business? and/or an equivalent question,
f. enable the seller to receive answers back from the claimants
g. register whether the seller has received an answer back, or whether a communication channel (such as a phone conversation) has been opened between seller and claimant.

Note: The MPQ-RB can also include a step enabling a seller to offer to pay only verified payoff claimants (claimants who have passed a realbuyer inspection) for answers to market research queries.

Presenting Claimants—Got-Away Buyers—With Acceptance and Claim Data

The method above enables a seller to communicate with got-away buyers. To facilitate the asking of questions, the method can also include steps for showing any got-away buyer (claimant) the terms of the realbuyer payment offer that she accepted that are relevant to the market research question(s) that the seller wants to ask.

Thus, the method can include the steps of presenting any claimant (that the seller has selected to query) with the name of the product/service that she claims to have bought, the name of business that she claims to have bought from, the name of the product/service offered by the seller and, the name of the seller.

These data come from the acceptance record of the realbuyer payment offer that the claimant accepted, and also from the claim data that the claimant previously submitted.

These data can be presented in natural language as part of a question, for instance:
Dear Mary Smith,
You said that you bought a Sony Vaio PCG Notebook Computer. Why didn't you buy our IBM Thinkpad X30 Notebook Computer that you saw on our website?
Dear Mary Smith,
You said that you bought from PC Connection. Why didn't you buy from PC Mall after you called us?

A market research question can further automatically include additional data registered in an acceptance and in a claim, such as the date of purchase and the purchase amount.

Paying Got-Away Buyers for Their Responses to Market Research Questions

The inventive method can also include steps for enabling a seller to offer to pay claimants for responding to the market research questions above.

We assume that the system will include bank accounts for both sellers and claimants, so that the system can debit payment from the seller and credit the claimant. Or, we assume that the system will include means for simply registering payment obligations, which the system then passes on to a payment transfer entity.

Thus, the inventive method can present the seller with the option of entering a payment amount to go along with the seller's request to communicate with a claimant.

A claimant will then see the amount she is being offered, along with the request to communicate with—answer questions from—the seller.

The claimant can then accept or reject the request. If she accepts the request and answers the question(s) satisfactorily, her account will be credited with the payment.

Thus, the MPQ-RB can further include one or more of the following enhancement steps:
h. enable a seller to offer to pay claimants for answers to market research queries,
i. present claimants with a payment-for-answer(s) offer,
j. registering an acceptance by a claimant, and enabling the seller to query the accepting claimant,
k. upon the seller receiving an answer from a claimant, paying the claimant from the seller's bank account as specified by the seller offer (or registering that the seller owes the claimant as specified by the seller offer).

The method can also include steps for enabling a seller to approve or reject the claimant's response if the seller believes that the claimant is not answering honestly or that the claimant has not given an adequate response. Meta-rules of the method will determine what an adequate response is. The system can, therefore, also enable a system-authorized judge to decide disputes, should they arise.

Illustrations of the Methods Described Above

The illustration below is not meant to limit the scope of the inventive methods above.

We will assume that the MPQ-RB is implemented within a pay-for-placement directory system in which realbuyer payment offers are defined by search criteria. However, the steps described below would apply if the MPQ-RB were implemented either as a service bureau (which we define as a system that enables sellers and realbuyers to transact realbuyer payment offers, but that does not present those offers competitively, as in a pay-for-placement directory) or as a system that enables only one seller to offer payments to realbuyers for attention.

Assume a seller named Tempe Carpets uses the MPQ-RB via the system.

The system can then include steps (as described in U.S. patent application Ser. No. 10/042,975) for showing the manager of Tempe Carpets all the prospects who have accepted EV payment from Tempe Carpets in realbuyer pay-for-attention offers. The system can also show the payoff claimants and also the verified payoff claimants (verified realbuyers).

Assume the manager asks to see a list of payoff claimants. The system can then present a list, showing any of the following data:
the search criteria that each claimant used to find/accept the seller's payment offer,
the EV payment made to the claimant,
the date of the EV payment,
the type of advertising the claimant was exposed to, which can include visiting a website, calling the seller, viewing a video, receiving email or paper mail from the seller, and meeting with the seller,
what the claimant claimed to have bought,
who the claimant claimed to have bought from.

Further, the inventive method can include steps for enabling a seller to select claimants to communicate with according to search criteria, e.g., the name of the product bought or the name of the seller the claimant bought from.

For example, let us assume that the manager of Tempe Carpets has used the search term Bob's Carpets, the name of a direct competitor, as the condition of an RB payment offer.

Users who entered the term Bob's Carpets into the system may have found an RB payment offer from Tempe Carpets. Prospects who selected Tempe Carpets payment offer then received provisional EV payment.

Now, we assume that some users did select Tempe Carpets payment offer, and did win a first-stage bet and, further, claimed to be realbuyers who are eligible to be paid.

These claimants are people who claim to have bought from Bob's Carpets after having been exposed to Tempe Carpets advertising. These are the got-away buyers that the manager wants to communicate with—wants to pose market research questions to.

The manager asks the system to present this set of claimants—claimants who have accepted the RB offer and who have subsequently bought from Bob's Carpets.

The inventive method can include steps for enabling the manger seller to select (narrow) these claimants according to the kind of advertising they have been exposed to, i.e. website visit, phone call, video, mail, meeting/visit.

Let us assume that the manager chooses “phone call.” Then he will have selected claimants who have called Tempe Carpets but have chosen to buy from Bob's Carpets.

Now, as discussed, the inventive method can also include steps for enabling the manager to communicate with the claimants. The manager can ask questions such as, Why did you buy from Bob's Carpets and not from Tempe Carpets?

As discussed, the inventive method can include steps for enabling the seller to choose to communicate via email, web-form, IVR, or phone call.

Earlier we have said that the manager chose to view claimants who accepted RB payment offers associated with governed by the term Bob's Carpets. Thus, the system can provide the manager with automated email, web-forms, and/or interactive voice response “forms” in which the term Bob's Carpets is part of pre-set market research questions asking how claimants made their purchasing choices. The term Tempe Carpets can automatically be inserted into such forms as well. Or, the inventive system can enable the manager (seller representative) to customize the questions.

In the case of a phone call conversation between the manager and a claimant (got-away buyer) the system would not provide the content of the market research questions.

In the case of email communication, the method can include the following steps:
Present the manager with an email form enabling the manager to choose from pre-set questions such as, “Why did you buy from ______?” in which ______ is filled in by the search term that the manager selected.
Upon the manager selecting and confirming a question, an email with the question would then be sent to the selected claimant. As noted, the email communication could contain a payment offer as well.
The claimant could then answer the question via email, and the system would send the answer to the manager.

Likewise, in the case of web form, the method can include the following steps:
Present the manager with a web form enabling the manager to choose from pre-set questions such as, “Why did you buy from?” in which is filled in by the search term that the manager selected.
Upon the manager selecting and confirming a question, an alert would be shown in the claimant's “my account” section of the system, which would tell the claimant that he had a question “waiting,” which he could answer. As noted, the question could include a payment-for-response offer.
The claimant could then answer the question via web-form, and the system would pass the answer to the manager.

Likewise, in the case of IVR communication, the method can include the following steps:
Present the manager with a form enabling the manager to choose from pre-set questions such as, “Why did you buy from ______?” in which ______ is filled in by the search term that the manager selected.
Upon the manager selecting and confirming a question, an alert would be shown in the claimants “my account” section of the system, which would tell the claimant that he had a question “waiting,” which he could answer by calling a certain phone number and entering an identifying code. As noted, the alert could include a payment-for-response offer.
The claimant could then answer the question via IVR, and the system would pass the answer, identified by the code, to the manager.

In the case of a phone call conversation, the method can include the steps of:
Show an alert in the claimant's “my account” interface of the system, which would tell the claimant that a seller would like to ask him some market research questions, which he could answer by calling a certain phone number and talking with the manager. As noted, the alert could include a payment-for-response offer.
Provide the claimant a phone number that is switched or bridged through a system switch that registers the call and connects it to the manager (while not showing the claimant's phone number).
Register whether the call takes place or not.

Alternatively, the system could provide the manger with a phone number so that the manager initiates the call. The call is, likewise, switched or bridged through a system switch that registers the call and connects it to the claimant (while not showing the claimant's number).

Other arrangements are possible for connecting a call for a phone conversation.

As is apparent to those skilled in the art, all of the communications channel method described above can be modified, without losing the essential methodology of enabling a channel to be opened between seller and claimant (got-away buyer) and registering whether communication has taken place.

Letting a Seller Query Another Seller's Got-Away Buyers

We have described how a seller can query got-away buyers. It is also possible to enable a seller to query another seller's got-away buyers. We do not describe this possibility but note that the methods above can be extended to enable this kind of communication.

Direct But Different Method for Reaching Got-Away Buyers

We note that a separate method can be used to potentially identify and pay got-away buyers. The inventive system of U.S. application Ser. No. 09/536,727, Expected Value Method and System for Paying and Qualifying, can be used.

A seller can offer to pay any user to answer the question, Why didn't you buy our product/service? or Why didn't you buy from our business?, on the condition that the user matches the following qualification specified by the seller: some time in the recent past, she has bought a specified product/service or has bought from a specified business.

This method does not necessarily identify and pay people who were exposed to advertising about a seller's product/service.

But, it does enable a seller to find and ask questions of people who bought a specified product/service or bought from a specified business.

Note: Steps Previously Disclosed

Many of the steps described above are copied from U.S. patent application Ser. No. 10/700,836, which describes methods for paying organization realbuyers. This application is incorporated by reference.

1. a method for improving the operation of a specialized, online computer database system, called an EVSPQ-RB, that enables a seller to pay conditional, expected value payments to realbuyer prospects for their attention to a message, users of which being able to accept EV payment offers;
users who accept these EV payment offers being eligible to win payoffs if they match the realbuyer conditions specified via the system by the paying seller;
said EVSPQ-RB recording the users who have accepted a seller's payment offer and who also have claimed a corresponding payoff,
the inventive method for improving said EVSPQ-RB comprised of the following steps:
a. upon a seller's request, presenting the seller a list of users who have claimed a payoff from an offer made by said seller via the EVSPQ-RB,
b. enabling said seller to specify and view a list of claimants by the product or service bought, or by who the seller bought from,
c. enabling said seller to select any of the claimants in the list to be queried,
d. enabling said seller to query the selected claimant(s) via email, web form, interactive voice response, and/or phone conversation,
e. enabling said seller ask payoff claimants a market research question,
f. enabling said seller to receive answers back from the claimants.
